(19) United States
(12) Patent Application Publication
(10) Pub. No.: US 2003/0033440 A1
(43) Pub. Date: Feb. 13, 2003

(54) Method of logging message activity

(75) Inventors: Andrew I. Hickson, West Wellow (GB); Andrew J. Stanford-Clark, Chale (GB)

Correspondence Address: Jeffrey S. LaBaw, IBM Corp, IP Law,, 11400 Burnett Road, Zip 4054, Austin, TX, 78758, US

(73) Assignee: International Business Machines Corporation

(21) Appl. No.: 10/087,963

(22) Filed: Feb. 27, 2002

(30) Foreign Application Priority Data
Aug. 9, 2001 (GB) 0119423.2

(51) Int. Cl. G06F 9/46

(52) U.S. Cl. 709/313

(57) ABSTRACT

A reduction in the amount of information written to a log used to track message activity in a messaging system is achieved by not logging message data in a log record for the put of a message if the message data has been included in a previous message and is already available in the log. On receipt of a put request a check is made to see if there is a previous occurrence of the message data in the log. If there is not a previous occurrence a log record is written which includes the message data, but if there is a previous occurrence a log record is written which does not contain the message data but a reference which can be used to locate the previous occurrence of the message data in the log. Preferably the application includes an indication on the put request that the message data has been previously used.

### FIELD OF THE INVENTION

The present invention relates, in general, to messaging within a distributed data processing environment and, in particular, to logging message activity in such an environment.

### BACKGROUND TO THE INVENTION

Asynchronous transfer of messages between application programs running on different data processing systems within a network is well known in the art, and is implemented by a number of commercially available messaging systems. These systems include IBM Corporation's MQSeries family of messaging products, which use asynchronous messaging via queues. A sender application program issues a PutMessage command to send (put) a message to a target queue, and MQSeries queue manager programs handle the complexities of transferring the message under transactional control from the sender to the target queue, which may be remotely located across a heterogeneous computer network. The target queue is a local input queue for another application program, which retrieves (gets) the message from this input queue by issuing a GetMessage command asynchronously from the send operation. The receiver application program then performs its processing on the message, and may generate further messages. MQSeries and IBM are trademarks of International Business Machines Corporation.

Transactional control of message transfer gives assured once and once-only message delivery of messages even in the event of system or communications failures. MQSeries products provide assured delivery by not finally deleting a message from storage on a sender system until it is confirmed as safely stored by a receiver system, and by use of sophisticated recovery facilities. Prior to commitment of transfer of the message upon confirmation of successful storage, both the deletion of the message from storage at the sender system and insertion into storage at the receiver system are kept ‘in doubt’ and can be backed out atomically in the event of a failure. This message transmission protocol and the associated transactional concepts and recovery facilities are described in international patent application WO 95/10805 and U.S. Pat. No. 5,465,328.

One key aspect of providing such transactional capabilities is the maintenance of a log in each system. The log, which may comprise one or more files, is used to keep a track of completed message activity in the system. Each time a message is sent to a queue a record that the message was sent, including the message data, is written to the log, and each time a message is retrieved from a queue a record that the message was retrieved is written to the log. Each of these writes to the log are forced to disk (although some may be combined to a single force) because in the event of a failure the log is used to recover each queue to the state it was in at the point when the failure occurred. Such a failure could be, for example, due to a power loss causing immediate termination of the system. As a result, in order to provide such capabilities as once and once only delivery of messages, recovery cannot tolerate a log record being lost because, for example, it was buffered by the operating system at the point of failure.

Unfortunately however, forcing a log write to disk is a relatively slow operation and can have a significant impact on the performance of message delivery and retrieval. Further forcing a log write can be slower for larger writes and specifically when writing records relating to message sends which include the message data which is potentially large.

### SUMMARY OF THE INVENTION

Accordingly, according to a first aspect the present invention provides a method for recording message activity in a log, the method comprising the steps of: receiving a request from an application to put a message, comprising message data, to a queue; and detecting whether there is a previous occurrence of the message data in the log, and if there is not a previous occurrence writing a log record including the message data, but if there is a previous occurrence writing a log record including a reference for locating the previous occurrence of the message data in the log.

According to a second aspect the present invention provides a method for detecting the re-use of message data comprising the steps: receiving a request from an application to put a message, comprising message data, to a queue; and deducing, based on an indicator included with the request, that the message data was previously put to a message queue or got from a message queue by the application.

According to a third aspect the present invention provides a computer program comprising instructions which, when executed on a data processing host, causes said host to carry out a method of the first or the second aspect.

According to a fourth aspect the present invention provides a data processing apparatus comprising: a non-volatile memory storage device for storing log records thereon in a log comprising one or more log files; a volatile memory storage device; means for receiving a request from an application to put a message, comprising message data, to a queue; means for detecting whether there is a previous occurrence of the message data in the log; means responsive to failing to detect a previous occurrence of the data in the log for writing a log record including the message data; and means responsive to detecting a previous occurrence of the data in the log for writing a log record including a reference for locating the previous occurrence of the message data in the log.

According to a fifth aspect the present invention provides a data processing apparatus comprising: means for receiving a request from an application to put a message, comprising message data, to a queue; and means for deducing, based on an indicator included with the request, that the message data was previously put to a message queue or got from a message queue by the application.

Thus the present invention reduces the size of selected records written to the log by a message processing system. When a message is put to a queue by an application a log record is written to the log which in the prior art includes the message data. However, according to the present invention, if the message data was included in a previous put and the message data from the previous put is available in the log, a reference to the previous occurrence of the message data in the log is included in the log record rather than the message data itself. As the message data is potentially large and the reference relatively small, less data is written to the log. Note that the previous put could be from the same application or a different application running on the same or a different data processing host.

Preferably the put request includes an indication that the message data was retrieved by the application in a previous request to get a message from the queue. This makes it easier to discover if the message is available in the log and this need only be done for message data that has previously been written to the log.

Preferably the put request includes an indication that the message data was included in a previous request, from the application, to put a message to a queue. This also makes it easier to discover if the message is available in the log.

Optionally the indication is a value which indicates that the message data was involved in the immediately preceding request from the application. For example it could indicate that the message data was also the message data included in an immediately preceding put request from the application. Further it could indicate that the message data was included in the message retrieved by the application in an immediately preceding get request. Note that the value could be a boolean value or, if it is required to know whether the immediately preceding request was a put or a get, a value (or values) comprising at least two bits.

Alternatively the indication is a token which uniquely identifies the message data within the scope of the application. This enables an application to identify message data that was involved in any preceding request. For example, if the token is an integer, when the application first requests a message, with message data, to be put to a queue, the message data could be assigned the value 1. Next time the application wishes to put a message containing the same message data it can specify the value 1 to indicate that the message data was previously put. Similarly a token can be assigned by the messaging system on a get request.

Preferably in processing an application request to get a message from a queue the message processing system stores a reference, separate from the log and associated with the application, from which a previous occurrence of the message data can be found in the log. Preferably the reference is stored in volatile memory. This enables rapid access to the reference should the application subsequently request that a message, which includes the same message data, is put to a queue.

Preferably if, following a put request it is detected that there is no previous occurrence of message data in the log, in addition to writing a log record including the message data, a reference is stored, separate from the log and associated with the message, for subsequently locating the message data in the log. Preferably the reference is stored in volatile memory. This enables rapid access to the reference when a different application issues a get request to get the message.

### BRIEF DESCRIPTION OF THE DRAWINGS

The invention will now be described, by way of example only, with reference to a preferred embodiment thereof, as illustrated in the accompanying drawings, in which:

FIG. 1 is a block diagram of data processing environment in which the preferred embodiment of the present invention is advantageously applied;

FIG. 2 is a schematic diagram of typical log contents according to the prior art; and

FIG. 3 is a schematic diagram of typical log contents according to the preferred embodiment of the present invention.

FIG. 4 is a flow chart of the method for processing a putMessage request according to the preferred embodiment of the present invention.

FIG. 5 is a flow chart of the method for processing a getMessage request according to the preferred embodiment of the present invention.

Note that in the figures, where a like part is included in more than one figure, where appropriate it is given the same reference number in each figure.

### DETAILED DESCRIPTION OF THE PREFERRED EMBODIMENT

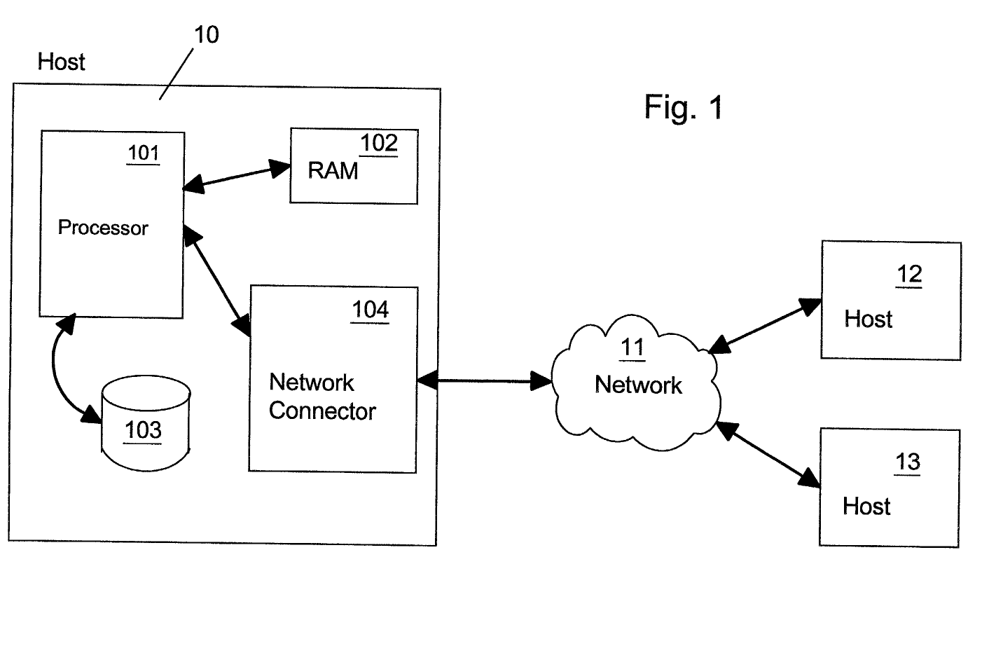

In FIG. 1, a data processing host apparatus 10 is connected to other data processing host apparatuses 12 and 13 via a network 11, which could be, for example, the Internet. The hosts 10, 12 and 13, in the preferred embodiment, comprise messaging systems which cooperate to carry out the transfer of messages with guaranteed once and once only delivery. Although three hosts are shown, any number of similar hosts could be involved. Host 10 has a processor 101 for controlling the operation of the host 10, a RAM volatile memory element 102, a non-volatile memory element 103 on which a log of message activity is stored, and a network connector 104 for use in interfacing the host 10 with the network 11 to enable the hosts to communicate.

In the messaging system of the preferred embodiment, messages are put (or sent) to a queue using a putMessage command and got (or retrieved) from a queue using a getMessage command. Messages comprise control information and data, where the data can comprise any number of bytes and are frequently many thousands of bytes. Further the messaging system maintains a log, comprising one or more files, on each data processing host on which it resides. The log is used to track message activity such that, in the event of failure of a messaging system on a data processing host, each message queue on that data processing host can be recovered to the state it was in before the failure occurred. Each log file, known as an extent, is of a fixed size and is used to store log records, in chronological order, relating to message activity for one or more queues. When an extent file becomes full a new extent is opened, each extent being numbered sequentially. Periodically a maintenance operation, known as checkpointing, is performed in which extents that no longer contain information required for recovery are made redundant and can be deleted. Any log record written to a log file that has not been marked redundant is available to be read and the position of each log record is known by the extent number of the extent in which it is contained and an offset within that extent. Note that in other embodiments, for example, the log could comprise a database or one or more circular files.

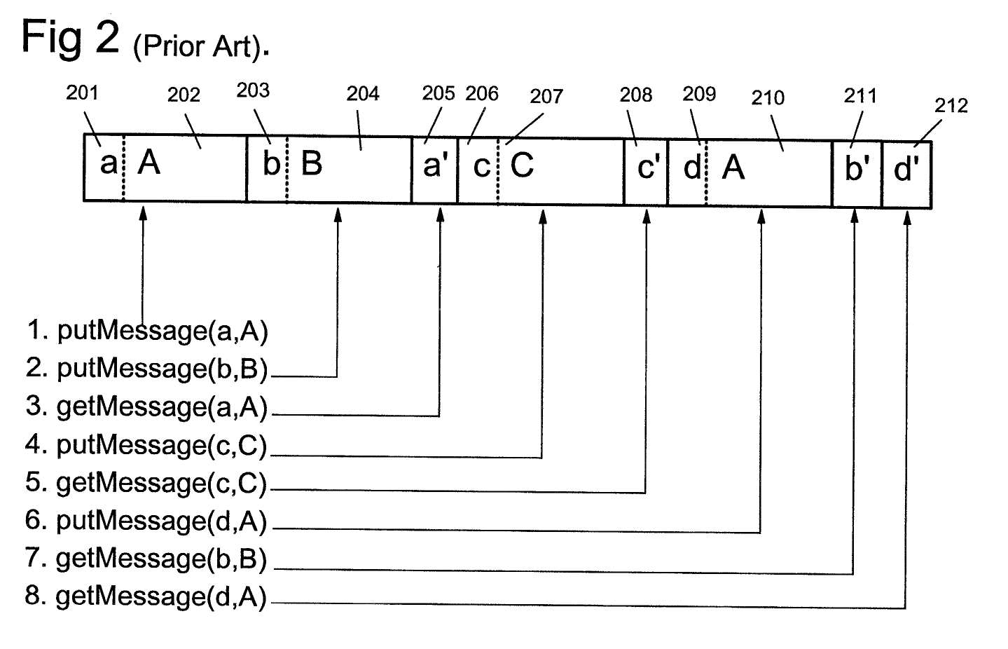

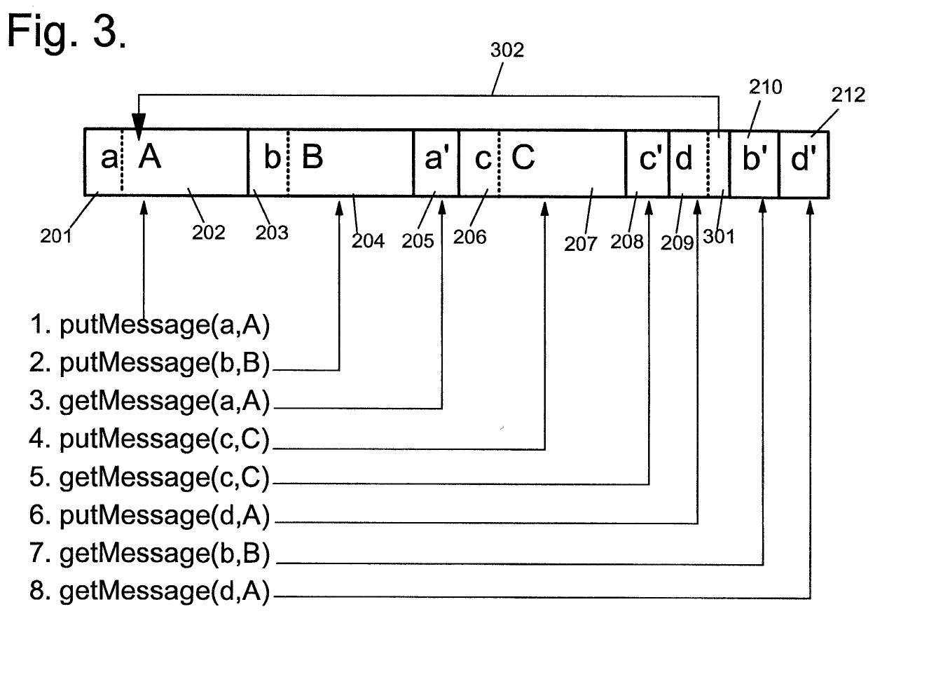

FIG. 2, shows schematically an example of the typical contents of a log, in a prior art messaging system, for a specified sequence of requests. Note that the requests in the sequence may be issued by one or more applications and represent only one of the possible sequences of requests received by a messaging system. Note also that the format of the requests shown is merely illustrative. The first request puts a message, comprising control information “a” and data “A”, to a message queue. Details of this message are then written to the log in a log record (201, 202) which comprises two elements, the control information (201) and the data (202) as specified by the application. Message control information is relatively small and can include such information as a message id and chaining information which will be processed by the receiving application. Message data is the content of the message to be sent and is potentially very large. Note that in the FIGS. 2 and 3 the relative sizes of the log records and record elements are not to scale. Further log records may contain one or more other elements, for example to allow navigation of the log, which are not shown.

The second request puts a message, comprising control information “b” and data “B”, to a message queue. This may or may not be the same message queue as the first message. The log record (203, 204) for the put of this message comprises similar information as the log record written for the put of the first message, and in fact similar information as the log record written for the put of any message, namely the message control information and data. The third request retrieves the previously put message with data “A”, and as a result a record (205) is written to the log to record this fact. Note that this type of record is relatively small as it contains no application data. The next two requests are a put and get of a message comprising control information “c” and data “C”, which result in a large log record (206, 207) associated with the put and a small log record (208) associated with the get. The next request is a put of a message comprising control information “d” and data “A”. This request may be from the same application that previously put the message with data “A” or the application that previously got the message with data “A”. Either way a log record (209,210) is written to the log similar to the previous records associated with the put of a message. The final two requests get messages with data “B” and “A” respectively resulting in two small log records (211, 212) to note the fact.

FIG. 3, shows schematically an example of the typical contents of a log file, in the preferred embodiment of the present invention, for the sequence of requests shown for FIG. 2. For the first 5 requests the log contents are the same as FIG. 2. However, when the message comprising control information “d” and data “A” is put to a queue the contents of the log diverge from those of FIG. 2. The put of this message results in a log record (209, 301) being written to the log which contains the control information “d” specified with the put request and a reference, depicted by arrow 302, to the previous log record (201, 202) which contains the message data “A”. Note that the reference comprises the extent number and offset. As a result log record (209, 301) does not include the message data “A” where equivalent log record (209, 210) in FIG. 2 does, and therefore potentially much less information, depending on the size of the message data, is written to the log. The remainder of the contents of the log are the same as for FIG. 2.

Note that the reference (301) recorded in the log may, for example, refer to the start of the log record (201,202) containing the data. Alternatively it could refer to a position, such as the position of the data (202) within the log record (201,202). Further, if the same message data is included in a series of messages such that it is put and got more than once, the reference (301) may refer to a record within a chain of one or more records that ends with the record containing the message data.

In the example shown in FIG. 3 the amount of log space saved, and therefore the performance improvement gained, may not appear to be very significant. However it is relatively common for an application to get a message from an input queue and put a message containing the same data to one or more output queues. For example Publish/Subscribe is commonly used in this way. As a result the improved performance and saved log space can be significant to such applications.

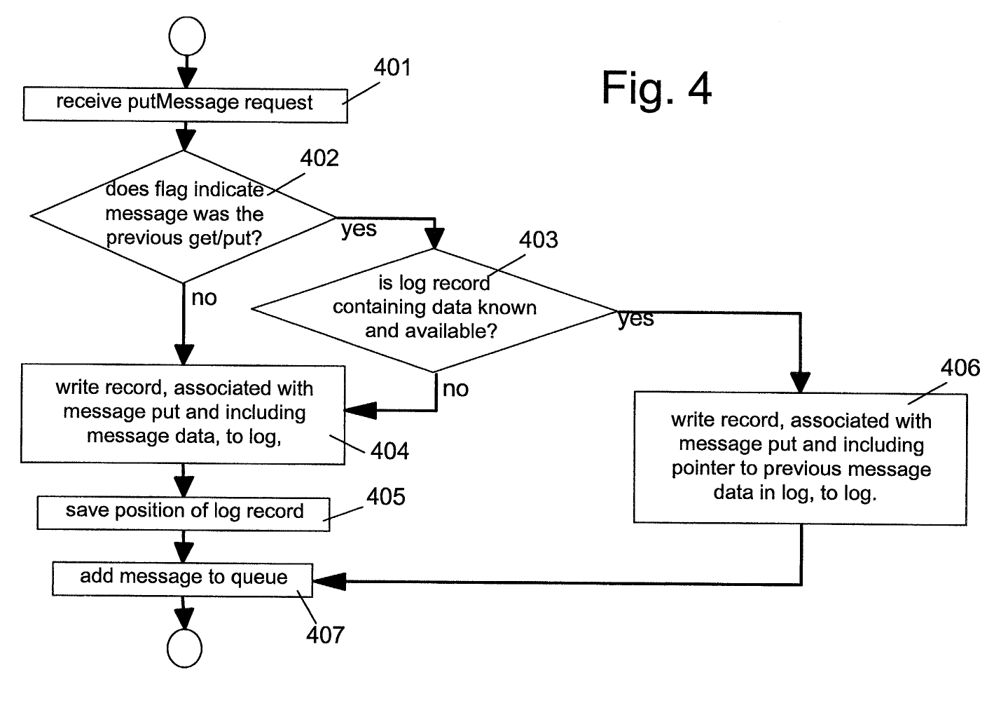

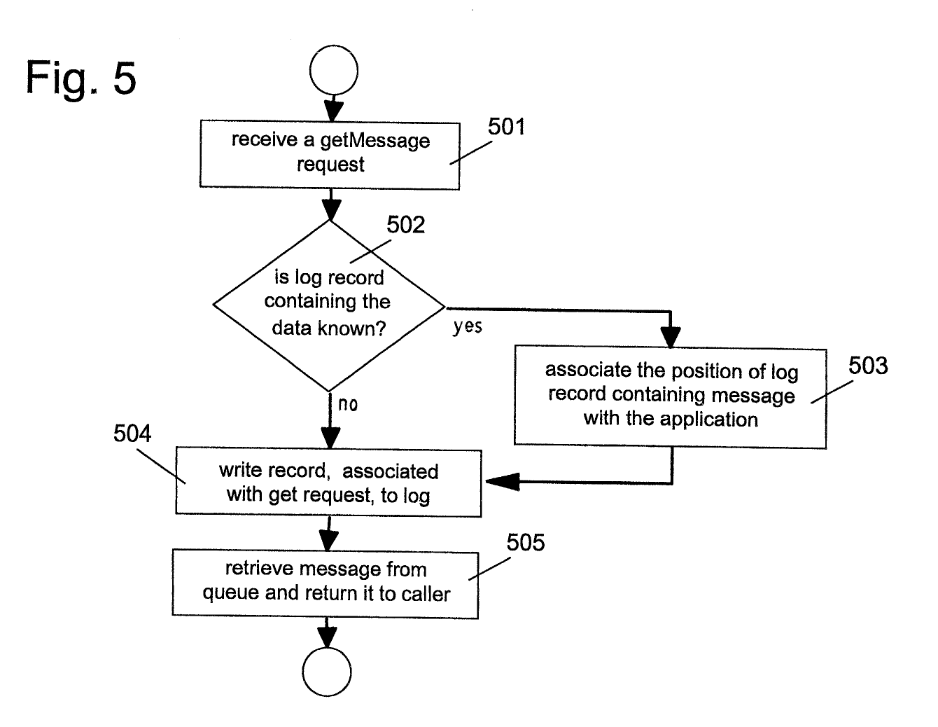

In order to use the method of writing information to the log file as described for FIG. 3, the messaging system must be able to recognize that a message being put contains data that has previously been put and therefore has already been written to the log. There are many ways of doing this. The method employed in the preferred embodiment requires a flag which is added to the putMessage request by an application and indicates whether the message being put contains the same message data as the previous message got or put by the application. This method is illustrated in FIGS. 4 and 5. In other embodiments the messaging system could, for example, scan the log for the data or save in storage an abbreviated form of message data, such as a hash value, with which the message data specified on a put request can be compared.

FIG. 4 shows the processing of a put request according to the preferred embodiment of the present invention. The processing of a message containing data that has not previously been put in a message will now be described with reference to FIG. 4. At step 401 a putMessage request is received from an application. At step 402 a check is made for an indication on the putMessage request that the message data is the same as that of the previous put or get by the application. In this scenario this indication is not set and processing continues to step 404 where a record is written to the log containing details of the message, including the message data. At step 405 a reference, comprising a position in the log (extent number and offset), to the log record just written is saved in volatile storage and associated with the message and the application. This enables the position of the log record containing the data to be obtained, without accessing the log, both during processing of a get request for the message even if the request is received from a different application and during a second put request by the same application. Finally at step 407 the message is added to the queue specified in the request.

FIG. 5 shows the processing of a get request according to the preferred embodiment of the present invention. At step 501 a getMessage request is received from an application. At step 502 a check is made to see if the position in the log of the log record containing the message data is known. This will have been stored and associated with the message at step 404 of FIG. 4. However, as some messages may remain in a queue for a long period, the position of the log record previously stored may have been removed from volatile storage based on a maintenance algorithm which is not part of the present invention. If the position of the log record is known it is, at step 503, associated with the application, which may require its duplication in volatile storage. Whether or not the position of the log record was known processing of the getMessage request completes at step 504 where a record is written to the log to indicate that the message has been retrieved and step 505 where the message is returned to the requester (i.e.: the application that issued the getMessage request).

The processing of a putMessage request containing message data that has previously been put in a message will now be described with reference to FIG. 4. At step 401 a putMessage request is received from an application. At step 402 a check is made for an indication on the putMessage request that the message data is the same as that of the previous put or get by the application. In this scenario this indication is set and processing continues to step 403 where a check is made to see if the position of the log record containing the message data is known and is available. It will be known if its position in the log was previously stored in volatile storage, and associated with the application, at either step 405 in FIG. 4 or step 503 of FIG. 5, and this has not been subsequently been removed from volatile storage by a maintenance operation. It will be available if the log record is still available in the log. The log record may not be available, for example, if a message data is re-used a long time after it was originally logged and the extent file in which it was written has been made redundant as part of a completed checkpoint operation, or is scheduled to be made redundant once an in-progress checkpoint operation has completed. If the position of the log record is known and is still available in the log, a log record is written to the log which comprises the message control information and a reference, comprising a position in the log (extent number and offset), to the log record that contains the message data. However if the position of the log record is not known or the log record is not available processing continues with steps 404 and 405. At step 404 a record comprising the message control information and data is written to the log. At step 405 the position, in the log, of the log record just written is saved in volatile storage and associated with the message and the application. Note that step 405 is not executed after step 406 so that if message data is included in a series of messages such that, for example, if it is put and got more than once, the message data does not have to be accessed through a chain of log records. The method completes, following steps 405 and 406, by adding the message to the queue specified in the request at step 407.

Note that the method of FIG. 4 may be carried out in more than one host in the case where a putMessage request is received on a given data processing host to place a message on a queue in a remote data processing host. As a result for a single message the steps of FIG. 4 may be carried out in two hosts where some steps are performed on both hosts and other steps are performed on just one of the hosts. For example step 401 is likely to be only carried out on the host on which the request is received and step 407 only on the host on which the queue exists whereas all other steps are likely to be carried out on both hosts although this will be implementation dependent.

Thus the preferred embodiment of the invention has been described whereby a log record may be written to the log, as part of the processing a put request, that does not include the message data but a reference to a previous occurrence of the message data in the log. Although the preferred embodiment carries this out for messages that contain the same data when they are either put in consecutive requests or put immediately after get, in other embodiments only one of these options may be implemented.

Further, in another embodiment, message data could be associated with a reference unique to the data and within the requesting application. This would be assigned by the application on a put request and by the messaging system on a get request. This would allow a subsequent put request to specify the reference in order to indicate that the data had previously been put or got by the application and therefore written to the log. This would remove the restriction in the preferred embodiment that, for example, a get request must be immediately followed by a put request with the same data in order to take advantage of the invention.

Further, it is possible that message data is duplicated in storage other than a log used to track message activity. As a result the methods disclosed in the present invention for detecting re-use of message data for the purpose of reducing the amount of data written to the log could be used in isolation for reducing duplication of the message data in other areas of storage.

1. A method for recording message activity in a log, the method comprising the steps of:
receiving a request from an application to put a message, comprising message data, to a queue; and
detecting whether there is a previous occurrence of the message data in the log, and if there is not a previous occurrence writing a log record including the message data, but if there is a previous occurrence writing a log record including a reference for locating the previous occurrence of the message data in the log.

2. A method as claimed in claim 1 wherein the request to put a message includes an indication that the message data was put to a message queue or got from a message queue in a previous request from the application.

3. A method as claimed in claim 2 wherein the indication is a value which indicates that the message data was involved in the immediately preceding request from the application.

4. A method as claimed in claim 2 wherein the indication is a token which uniquely identifies the message data within the scope of the application.

5. A method as claimed in claim 1 further comprising the steps:
receiving a request from the application to get a message, comprising message data, from a queue; and
storing a reference, separate from the log and associated with the application, for locating a previous occurrence of the message data in the log.

6. A method as claimed in claim 1 wherein if the detecting step detects that there is not a previous occurrence of the message data in the log it further stores a reference, separate from the log and associated with the message, for subsequently locating the message data in the log.

7. A method for detecting the re-use of message data comprising the steps:
receiving a request from an application to put a message, comprising message data, to a queue; and
detecting, based on an indicator included with the request, that the message data was previously put to a message queue or got from a message queue by the application.

8. A method as claimed in claim 7 wherein the indicator is a value which indicates that the message data was involved in the immediately preceding request from the application.

9. A method as claimed in claim 7 wherein the indicator is a token which uniquely identifies the message data within the scope of the application.

10. A computer program product, recorded on a medium, comprising instructions which, when executed on a data processing host, causes said host to carry out a method comprising the steps:
receiving a request from an application to put a message, comprising message data, to a queue; and
detecting whether there is a previous occurrence of the message data in the log, and if there is not a previous occurrence writing a log record including the message data, but if there is a previous occurrence writing a log record including a reference for locating the previous occurrence of the message data in the log.

11. A computer program product as claimed in claim 10 wherein the request to put a message includes an indication that the message data was put to a message queue or got from a message queue in a previous request from the application.

12. A computer program product as claimed in claim 11 wherein the indication is a value which indicates that the message data was involved in the immediately preceding request from the application.

13. A computer program product as claimed in claim 11 wherein the indication is a token which uniquely identifies the message data within the scope of the application.

14. A computer program product as claimed in claim 10 further comprising the steps:
receiving a request from the application to get a message, comprising message data, from a queue; and
storing a reference, separate from the log and associated with the application, for locating a previous occurrence of the message data in the log.

15. A computer program product as claimed in claim 10 wherein if the detecting step detects that there is not a previous occurrence of the message data in the log it further stores a reference, separate from the log and associated with the message, for subsequently locating the message data in the log.

16. A computer program product, recorded on a medium, comprising instructions which, when executed on a data processing host, causes said host to carry out a method comprising the steps:
receiving a request from an application to put a message, comprising message data, to a queue; and
detecting, based on an indicator included with the request, that the message data was previously put to a message queue or got from a message queue by the application.

17. A computer program product as claimed in claim 16 wherein the indicator is a value which indicates that the message data was involved in the immediately preceding request from the application.

18. A computer program product as claimed in claim 16 wherein the indicator is a token which uniquely identifies the message data within the scope of the application.

19. A data processing apparatus comprising:
a non-volatile memory storage device for storing log records thereon in a log comprising one or more log files;
a volatile memory storage device;
means for receiving a request from an application to put a message, comprising message data, to a queue;
means for detecting whether there is a previous occurrence of the message data in the log;
means responsive to failing to detect a previous occurrence of the data in the log for writing a log record including the message data; and
means responsive to detecting a previous occurrence of the data in the log for writing a log record including a reference for locating the previous occurrence of the message data in the log.

20. An apparatus as claimed in claim 19 wherein the request to put a message includes an indication that the message data was put to a message queue or got from a message queue in a previous request from the application.

21. An apparatus as claimed in claim 20 wherein the indication is a value which indicates that the message data was involved in the immediately preceding request from the application.

22. An apparatus as claimed in claim 21 wherein the indication is a token which uniquely identifies the message data within the scope of the application.

23. An apparatus as claimed in claim 19 further comprising:
means for receiving a request from the application to get a message from the queue; and
means for storing a reference, separate from the log and associated with the application, for locating a previous occurrence of the message data in the log.

24. An apparatus as claimed in claim 19 further comprising:
means responsive to failing to detect a previous occurrence of the message data in the log for storing a reference, separate from the log and associated with the message, for subsequently locating the message data in the log.

25. A data processing apparatus comprising:
means for receiving a request from an application to put a message, comprising message data, to a queue; and
means for deducing, based on an indicator included with the request, that the message data was previously put to a message queue or got from a message queue by the application.

26. A data processing apparatus as claimed in claim 25 wherein the indicator is a value which indicates that the message data was involved in the immediately preceding request from the application.

27. A data processing apparatus as claimed in of claim 25 wherein the indicator is a token which uniquely identifies the message data within the scope of the application.
